(19) United States
(12) Patent Application Publication
(10) Pub. No.: US 2003/0101063 A1
(43) Pub. Date: May 29, 2003

(54) Real estate information system

(76) Inventors: Ashley K. Sexton, Norris, TN (US); Thomas E. Von Berg, Knoxville, TN (US); Michael P. Morihan, Knoxville, TN (US)

Correspondence Address: LUEDEKA, NEELY & GRAHAM, P.C., P O BOX 1871, KNOXVILLE, TN, 37901, US

(21) Appl. No.: 09/966,807

(22) Filed: Sep. 28, 2001

(51) Int. Cl. G06F 17/60

(52) U.S. Cl. 705/1

(57) ABSTRACT

A computerized real estate information system accessible via a computer network for selectively providing information to users concerning real estate properties.

### FIELD OF THE INVENTION

This invention relates generally to selectively providing database information to users over a global computer network. More particularly, this invention relates to a method and system for selectively providing information relating to real estate properties to users over a global computer network that enables users to selectively view information concerning desired properties and to generate and disseminate information packages concerning such properties.

### BACKGROUND AND SUMMARY OF THE INVENTION

In marketing real estate, it is desirable to deliver information concerning properties to those persons primarily interested in that type of property. This tends to increase sales efficiencies and reduce costs associated with the marketing of property. It is also desirable to provide information about properties in a manner that effectively meets the inquiry needs of potential buyers, lessees or the like. That is, that information suitable for effective consideration of the property is provided to interested persons.

The present invention is directed to a computerized real estate information system accessible via a computer network for selectively providing information to users concerning real estate properties.

In a preferred embodiment, the system includes a computer database of information corresponding to real estate properties, a user access interface operatively associated with the database for selectively accessing the database information, a portfolio interface operatively associated with the user interface for organizing information concerning selected ones of the real estate properties, and an administrative interface for entering the information corresponding to the real estate properties into the database and for editing the information.

The user interface includes a portal to a global computer network, a plurality of search data entry fields accessible via the portal for inputting desired search criteria for comparison to the database information to yield at least one search result corresponding to a subset of the database information that matches the input search criteria, a search result display that visually presents the search result, first package data entry fields for selecting desired database information for inclusion in a first package of information corresponding to a desired real estate property, and at least one first package output field for selecting a desired package output format.

The portfolio interface includes a plurality of portfolio folders for storing selected database information corresponding to at least one of the real estate properties, and a plurality of folder tools associated with each of the portfolio folders. The folder tools includes second package data entry fields for selecting desired database information for inclusion in a second package of information corresponding to a desired real estate property, and at least one second package output field for selecting a desired package output format.

In another embodiment, the system includes a computer database of information corresponding to real estate properties, a user access interface operatively associated with the database for selectively accessing the database information, a portfolio interface operatively associated with the user interface for organizing information concerning selected ones of the real estate properties, and an administrative interface for entering the information corresponding to the real estate properties into the database and for editing the information.

The portfolio interface is accessible via a login interface and includes tools to select information from the database and to generate a package corresponding to the selected information.

In one aspect, the package is customizable to include maps, community information, photographs, and demographic information. The system enables the user to print the package, electronically save the package, and disseminate packages to third parties. In this manner, comprehensive information concerning property may be quickly and easily compiled and distributed to others.

In another aspect, the package includes statistical information corresponding to marketing efforts of the listing user for properties listed by the listing user. The statistical information preferably includes data corresponding to the length of time each listed property of the listing user has been listed, when properties have been sold, how many other users have viewed, printed or e-mailed information relating to a particular property, and how many e-mails and other communications the listing user has sent concerning each property. This information is desirable to enable persons such as listing users to evaluate the effectiveness of their marketing efforts.

### BRIEF DESCRIPTION OF THE DRAWINGS

Further advantages of the invention will become apparent by reference to the detailed description of preferred embodiments when considered in conjunction with the figures, which are not to scale, wherein like reference numbers, indicate like elements through the several views, and wherein,

FIG. 1 is a functional block diagram for a real estate information system in accordance with a preferred embodiment of the invention.

FIG. 2 is a preferred home page of a Internet-based portal of a user access interface of the system of FIG. 1.

FIG. 3 is a preferred “quick search” input page of a user access interface of the system of FIG. 1.

FIGS. 4 and 5 are preferred “global search” input pages of a user access interface of the system of FIG. 1.

FIG. 6 is a preferred results output page of a user access interface of the system of FIG. 1.

FIGS. 7a-7c show preferred embodiments of user pages having detailed information concerning a selected property.

FIGS. 8a-8c show preferred images of property selectively displayable via the user interface.

FIGS. 9a-9e are enlarged images of maps provided in accordance with a preferred embodiment of the invention.

FIG. 10 is a preferred embodiment of a package selection page for selecting items to be included in a property package.

FIG. 11 is a preferred embodiment of a package output page that enables a user to view, print, or save a package.

FIG. 12 is a preferred embodiment of an inquiry page that enables a user to request additional information concerning a listed property.

FIG. 13 is a preferred embodiment of an e-mail access page that enables a user to send packages via e-mail.

FIG. 14 is a preferred embodiment of a user page for accessing portfolio information via the portfolio interface.

### DETAILED DESCRIPTION

The invention relates to a method and system for selectively providing information to users over a global computer network. The invention is suitable for a variety of uses such as the preferred use described herein with regard to commercial real estate. However, it will be understood that other information may be stored in the database, accessed and manipulated in the same manner as described herein for real estate. For example, the system is suitable for other properties to be sold, rented, leased, or traded such as boats, airplanes, and the like, as well as “time rental” properties such as billboards and cell telephone towers.

In a preferred embodiment, information relating to real estate properties is selectively provided to users over a global computer network in a manner that enables users to selectively view information concerning desired properties, to generate information packages concerning such properties, and to maintain information concerning properties. The information packages may be stored for future use, printed, or disseminated such as via electronic mail.

The system preferably includes a computer-based database of information about properties, such as commercial, industrial, improved, and unimproved real estate properties. An administrative interface enables the entering and updating of database information. A user access interface enables users, such as the public, to selectively access database information. The user access interface is preferably provided over a global computer network, such as the Internet. A portfolio interface enables organization of information concerning properties, generation of additional marketing materials, and the ability to review and manipulate statistical information related to the marketing efforts associated with listed properties.

In addition to allowing users to access information, the system enables users to selectively configure database information into viewable and printable reports or presentation packages and to generate statistical data corresponding to their marketing efforts. The packages and information may be stored for future reference and retrieval and dissemination as by electronic, e.g., “e-mail,” facsimile, and mail.

The system is particularly suited to be offered to professional users such as site selectors; real estate agents, property managers and the like who list and review property on a regular basis and maintain a vigil on marketed properties. The system is also suitable for enabling members of the general public to access information about properties.

The features of the system available to users are preferably able to be segregated between professional users and general users. For example, general users may preferably search the information database and print property information. If a general user desires to maintain a record of the properties they have searched and of packages they have generated, the general user may preferably store this information by setting up an account accessible as by password and user name that provides one or more storage folders for the search information as may be desired.

Users having listed properties are preferably enabled access, as by a password, to features of the system that not only enables storage of search information, but facilitates maintenance of records concerning properties, generation of marketing materials, and analysis of marketing efforts.

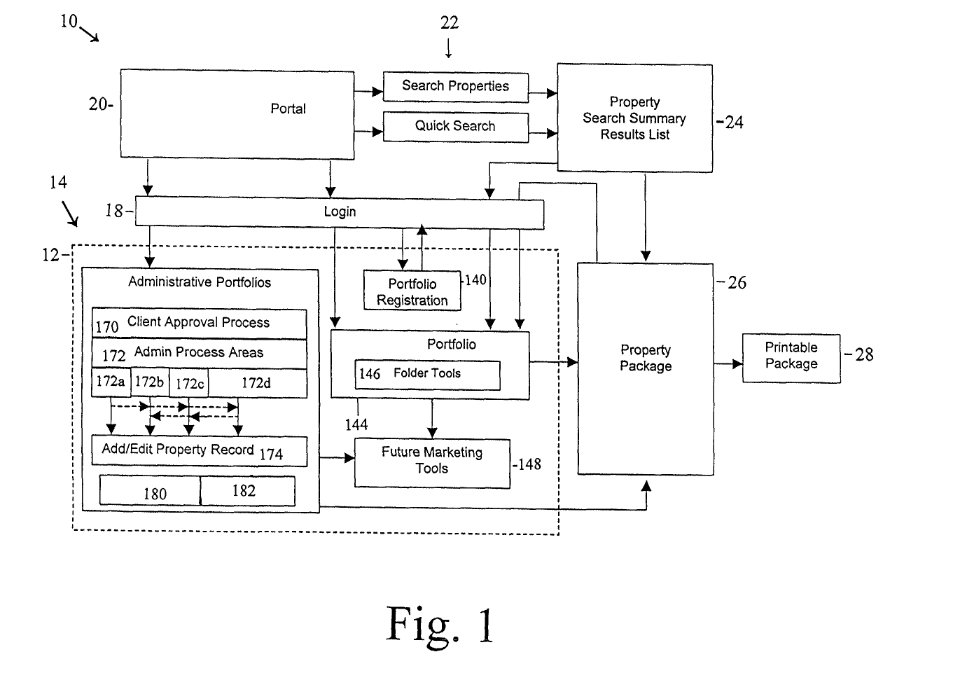

With initial reference to FIG. 1, there is shown a preferred embodiment of a functional block diagram for a user access interface 10, portfolio interface 12, and administrative interface 14 for the system. The portfolio interface 12 and administrative interface 14 are preferably protected from general access as by use of passwords and accessed via login interface 18.

User Interface 10

The user interface 10 enables users to selectively access database information and to selectively view and configure the selected information into reports and other visual displays corresponding to the selected information. This information may then be printed, disseminated, and stored for future retrieval.

The user interface 10 preferably includes a portal 20, a search input 22, a results output 24, a package input 26, and a package output 28.

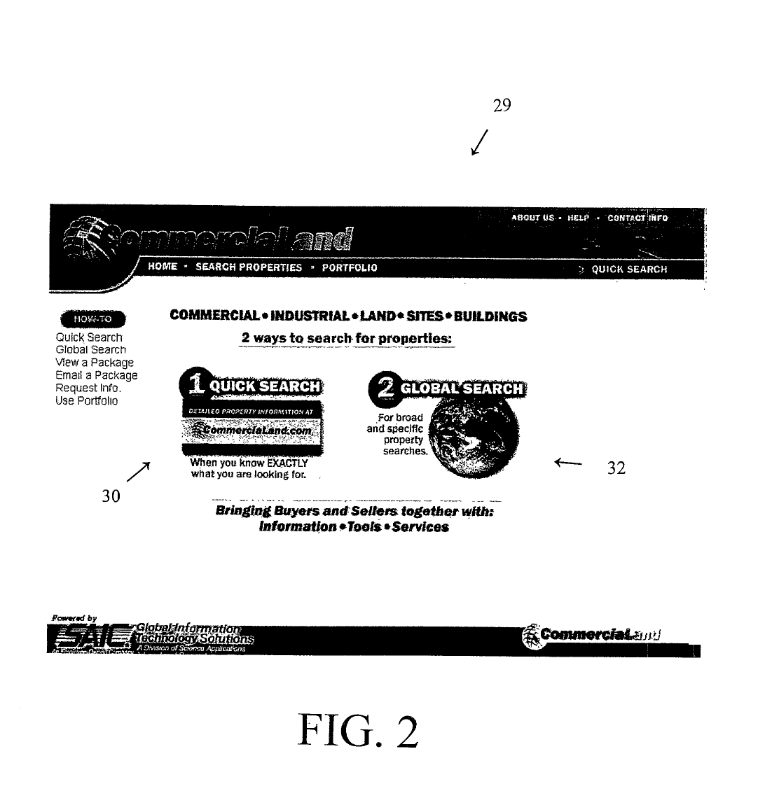

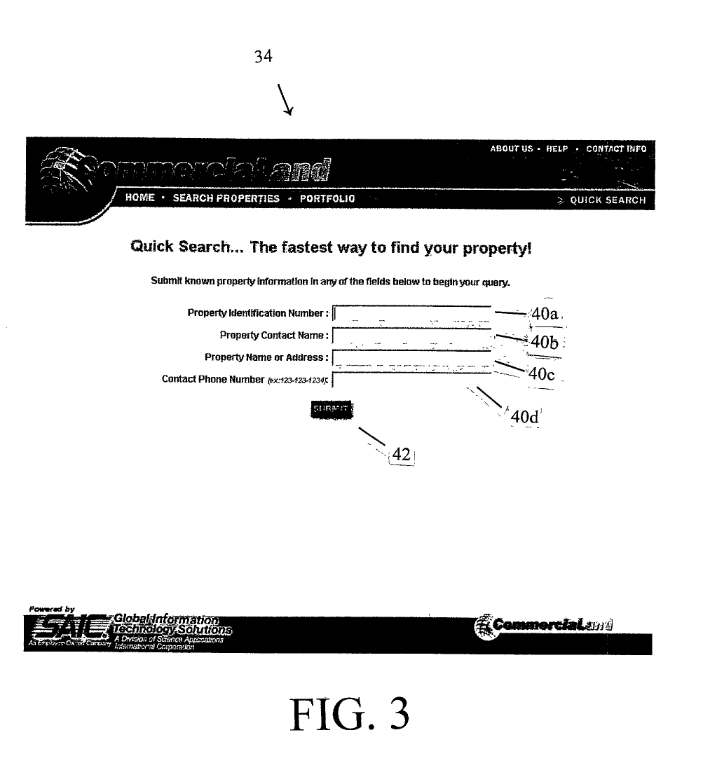

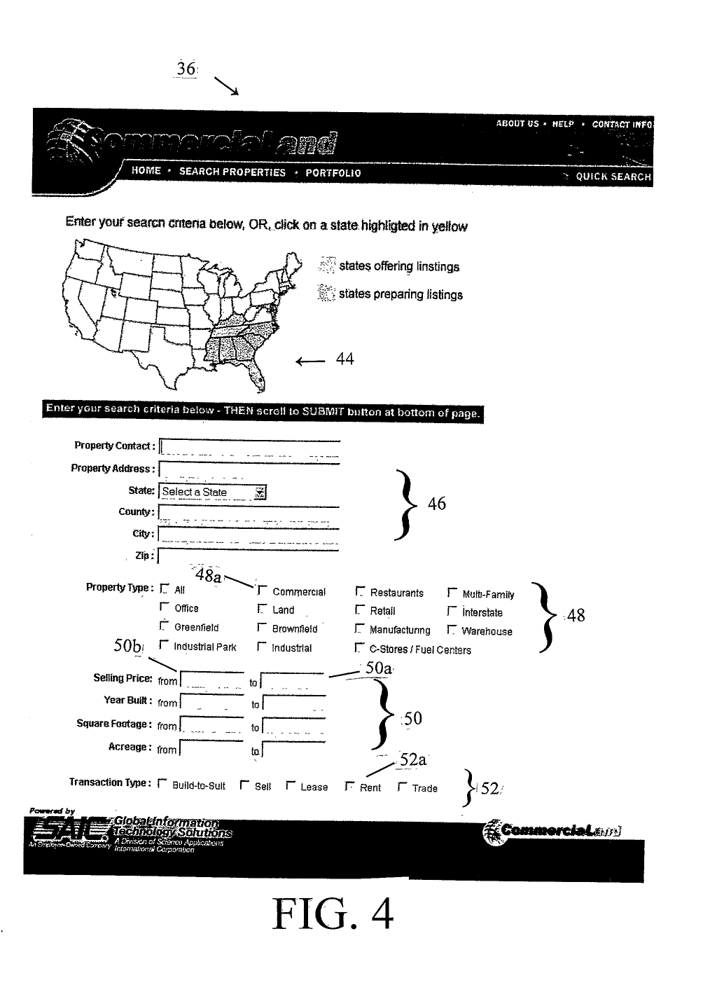

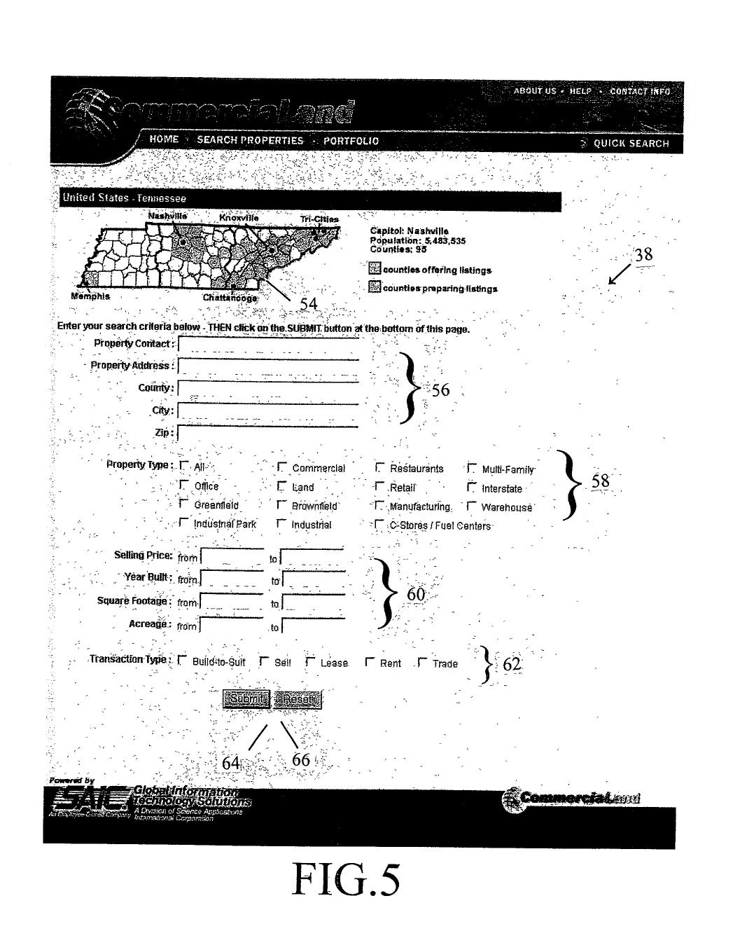

The portal 20 is preferably a publically accessible webpage located on a global computer network such as the Internet. FIG. 2 shows a preferred beginning or home page 29 of a Internet-based portal in accordance with a preferred embodiment of the invention. Users entering the site are preferably directed to the search input 22 as by icons 30 and 32 accessible as by clicking thereon with a computer mouse. Icon 30 directs users to a “quick search” input page 34 (FIG. 3) of the search input 22. Icon 32 directs users to “global search” input pages 36 and 38 of the search input 22 (FIGS. 4 and 5). Listing users may also search information within their portfolio folders.

With reference to FIG. 3, “quick search” input page 34 facilitates the input of search criteria that enables users to search for a specific property having a known identification number, address, or listing agent or other contact.

In a preferred embodiment, input page 34 preferably includes data entry fields 40a-40d. Information may be input into one or more of the fields for effecting a search.

Entry field 40a enables input of information corresponding to a predetermined property code for a particular property. The field 40a preferably accepts partial or full codes. For example, if the property code for a particular property is “018ch508” then input of any segment of that code, e.g., “018” or “ch,” will result in this property being a property retrieved by the search.

Entry field 40b preferably enables input of information relating to the property contact name, such as the real estate firm or the listing agent. The field 40b preferably accepts input of segments, e.g, partial or full portions, of the names. If this is the only field into which information is input, it enables selection of all properties in the database listed by a particular firm or agent.

Entry field 40c preferably enables input of information relating to a name or description of the property, e.g, “Riverview Tower,” or “restaurant,” or address information such as city, state, zip code, street name or the like. The field 40c preferably accepts inputs of segments of the information. If this is the only field into which information is input, it enables selection of all properties in the database having that criteria, e.g., all database properties on a certain street.

Entry field 40d preferably enables input of information relating to a contact phone number for the property or segments thereof. If this is the only field into which information is input, it enables selection of all properties in the database having that criteria, e.g., all database properties within an input area code.

A search may be performed of the database with regard to the information supplied to the fields 40a-40d as by a mouse click on submit icon 42. The results of the search are displayed to the user via the search output 24, described further below.

As an alternative search input, search criteria may be input as by the global search input page 36 or pages 36 and 38 collectively. For example, with reference to FIG. 4, the input page 36 preferably includes a map 44 and entry fields 46, 48, 50, and 52.

The map 44 is preferably a map showing geographical regions corresponding to geographical locations of properties having information included in the database. The map 44 is depicted as a map of the United States of America, with the State of Tennessee shaded to indicate that the database contains properties located in Tennessee. Other states are shaded differently to indicate that the database will soon include properties for these states. It will be understood that the map 44 may depict as much as the entire World or as little as a country, state, county, city, or neighborhood.

Interaction with map 44 is accomplished as by clicking a computer mouse on a state, e.g., for example the outline for the State of Tennessee. This action transfers the user to input page 38 of FIG. 5, discussed below.

With further reference to FIG. 4, the entry fields 46 preferably enable input of information such as that previously discussed in connection with FIG. 3. For example, entry fields 46 preferably enable information or segments thereof to be input with regard to “property contact,” “property address,” “state,” “county,” “city,” and “zip code.”

Input fields 48 preferably enable input of information relating to desired property types. As shown, this includes all property types in the database or selected ones. Examples of property types include office, greenfield, industrial park, commercial, land, brownfield, industrial, restaurants, retail, manufacturing, convenience stores/fuel center, multi-family, interstate, and warehouse properties. One or more of the fields may be selected as by clicking a box associated with the field using a computer mouse. For example, if the search is to be limited to commercial properties, a user may click on box 48a with a computer mouse.

Input fields 50 preferably enable input of information relating to desired price ranges, age, square footage, and acreage. For example, if it is desired to limit the search to properties having a selling price of less than $200,000, the value “200,000” may be typed into box 50a. If it is desired to limit the search to properties having a price above $100,000, then the value “100,000” may be typed into box 50b. If properties having a price from $100,000 to $200,000 are desired, then value “100,000” is typed into box 50b and the value “200,000” is typed into box 50a. In a similar manner, limiting criteria may be input for age, square footage, and acreage.

Input fields 52 preferably enable input of information relating to transaction type, examples of which include “build-to-suit,”“sell,” “lease,” “rent,” or “trade.” For example, if a user is only interested in rental properties, the “rent” field could be selected by clicking on the associated box 52a with a computer mouse.

A search may be performed of the database with regard to the information supplied to the fields 46-52 as by a mouse click on a submit icon. The results of the search are displayed to the user via the search output 24, described further below.

As noted above, interaction with map 44 transfers the user to input page 38 of FIG. 5. With reference to FIG. 5, page 38 preferably includes a map 54 of the selected geographic area, in this case the State of Tennessee. This map may be interacted with as by clicking with a computer mouse on a smaller geographic region thereof, e.g,. a city or county, to be transferred to yet another map of the selected area. This process may be continued to ultimately select a geographic area of virtually any size, e.g., such as down to a neighborhood or specific address.

For the purpose of example, however, there is no further interaction with the map 54 and the user inputs selection criteria into fields 56, 58, 60, and 62. As will be noted, the fields 56-62 are preferably substantially similar to the fields 46-52 discussed in connection with FIG. 4.

A search may be performed of the database with regard to the information supplied to the fields 56-62 as by a mouse click on a submit icon 64. Alternatively, if changes are desired to be made to the criteria, reset icon 66 may be clicked on.

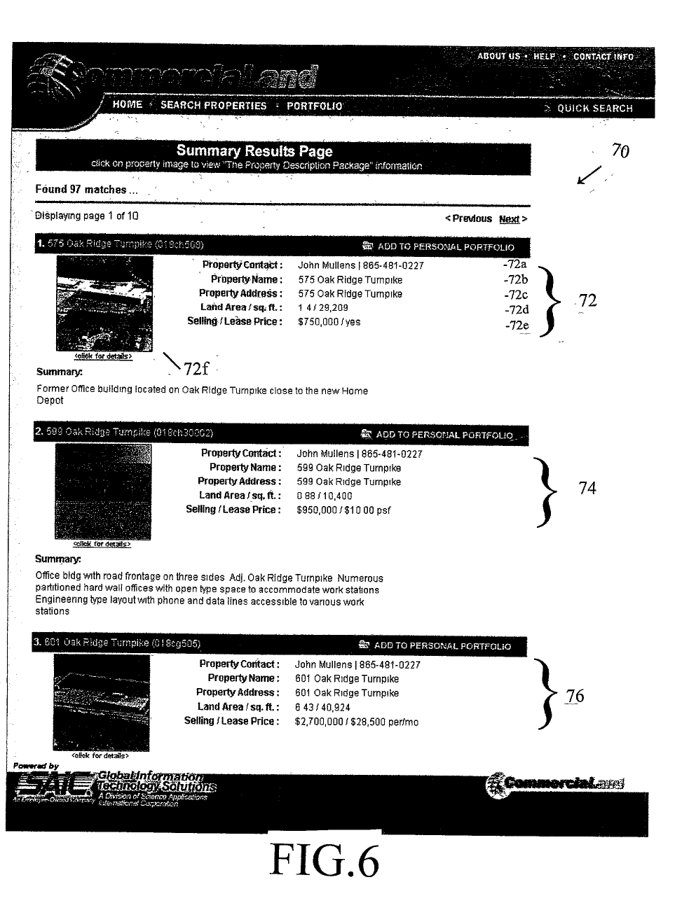

Turning now to FIG. 6, there is shown an example of a page 70 corresponding to a preferred presentation of the results output 24. The page 70 is generated by the system in response to a microprocessor-based search of the database using the search criteria input via the search input page 36 or pages 36 and 38.

The page 70 includes information corresponding to the properties selected from the database using the desired search criteria. This may range from as few as zero properties to all of the properties within the database. For the purpose of example, the page 70 displays three properties 72, 74, and 76 located by the search. As will be noted, each of the properties shares at least one data field, e.g., each share a common property contact and an address on Oak Ridge Turnpike.

For the purpose of example, the search criteria required “John Mullens” in the property contact field and an address field of “oak ridge turnpike.” The three displayed properties 72-76 thus represent all properties in the database meeting this criteria. The user may select one or all of the displayed properties as by clicking on the same to receive additional information.

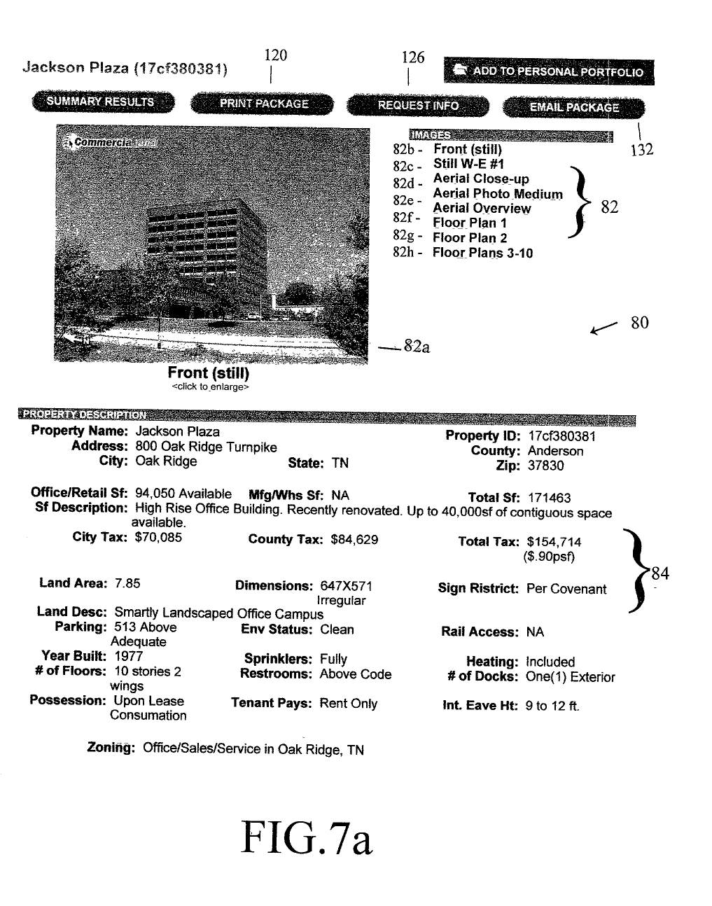

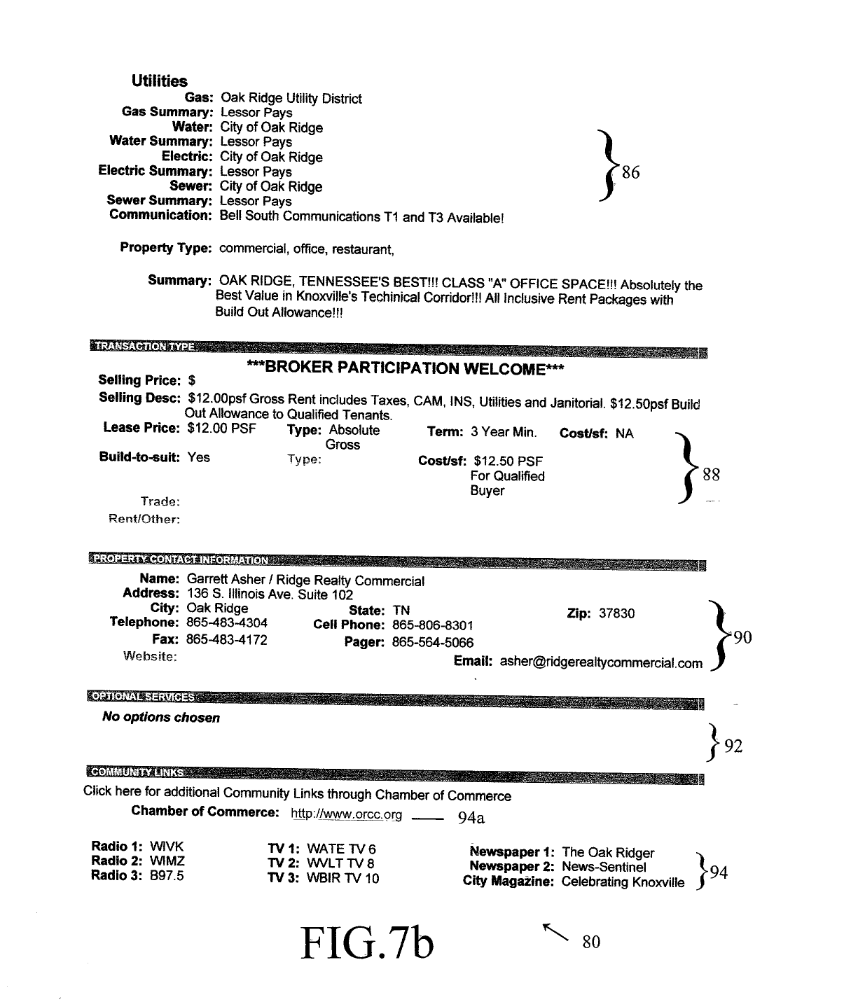

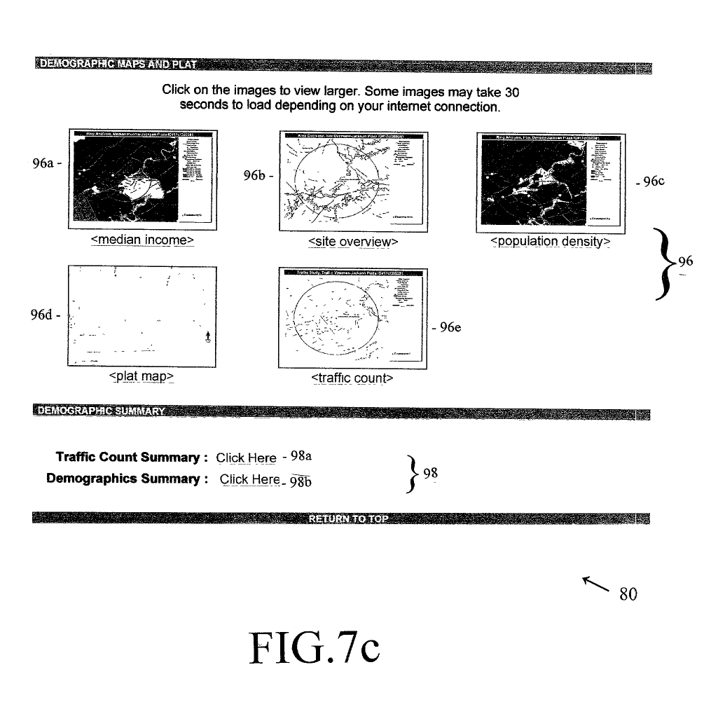

Data fields, such as data fields 72a-72e are preferably displayed along with a small or thumbnail image 72f corresponding to a photograph of the property, such as an aerial photograph of the property. The data fields selected to appear on summary page 70 are preferably of a type suitable to enable users to evaluate whether or not they desire additional information about a property and to enable users such as real estate agents to readily identify properties they are listing. For example, field 72a is “property contact,” field 72b is “property name,” field 72c is “property address,” field 72d is land area/square footage,” and field 72e is “selling/lease price.” Should a user desire additional information concerning a property, such as property 72, the user may click the image 72f associated with the property 72 to access a page 80 having additional information (FIGS. 7a-7c).

Page 80 is viewed in three sections in FIGS. 7a-7c, and preferably includes more detailed information concerning a selected property. For example, in a preferred embodiment, page 80 includes an image section 82 and a description section 84, both seen in FIG. 7a, a utility section 86, transaction section 88, contact section 90, optional services section 92, community section 94, all seen in FIG. 7b, map section 96 and demographic summary section 98, both seen in FIG. 7c. The page 80 represented by FIGS. 7a-7c may be separate pages but are preferably a single viewable page, the entirety of which may be viewed as by scrolling up and down on a computer screen using a computer mouse.

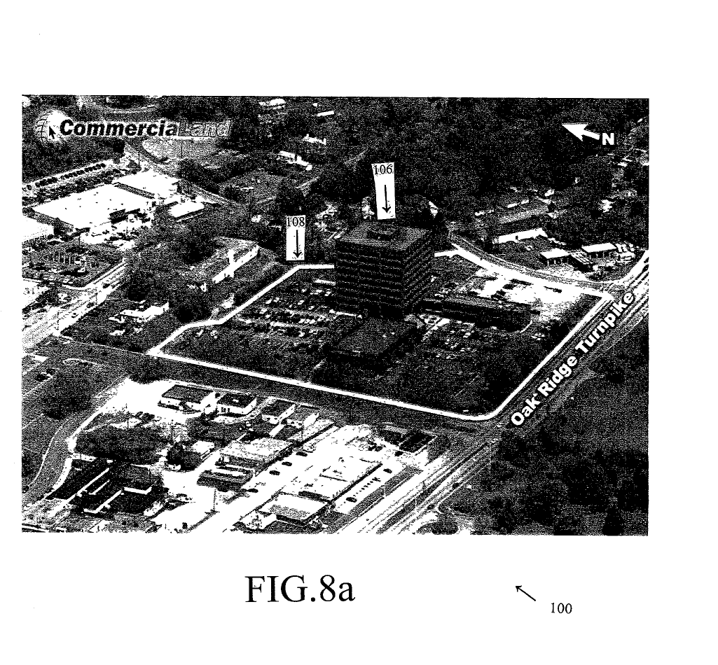

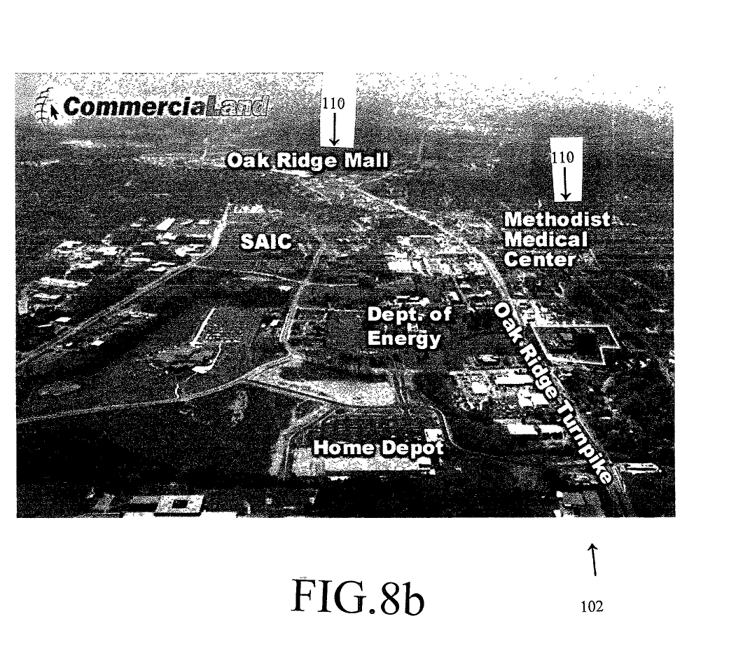

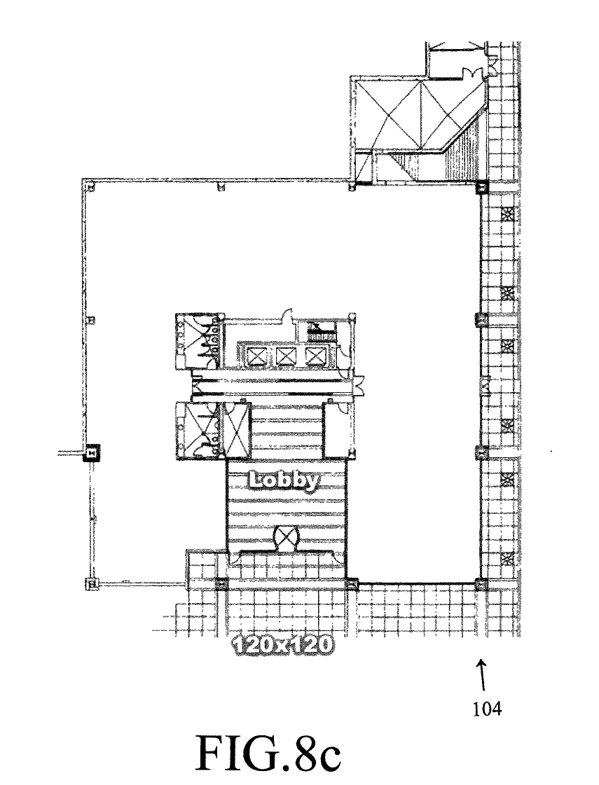

Image section 82 preferably includes image 82a which is a small or thumbnail size image of the property. The image 82a may be interacted with as by clicking thereon with a computer mouse to yield a larger image of the property. The image 82a is preferably a frontal view of the property. In addition, the image section 82 also preferably includes icons 82b-82h which enable access to other images of the property from different perspectives, e.g., rear, side and aerial views, and floor plans of the various levels of the building. For example, FIGS. 8a-8b show aerial views 100 and 102 accessed as by the icons 82c and 82d, respectively. FIG. 8c shows a floor plan 104 accessed as by icon 82f. Each of the views 100-104 may be printed if desired.

View 100 (FIG. 8a) is a relatively close-up aerial view of the selected property, represented by building and land 106. A preferred feature of the view 100 is the provision of a highlighted border 108 substantially corresponding to property lines of the property. A direction indicator N, preferably including an arrow pointing to direction, such as magnetic North is also included. These features readily enable a viewer to observe the boundaries of the property in relation to other properties and the general lay of the land.

View 102 (FIG. 8b) is preferably an aerial view of the property from a greater distance from the property than the view 100. As will be noticed, view 102 also preferably includes the border 108, and additionally includes identifications 110 corresponding to identifications of surrounding properties. For example, designations 110 preferably include street or highway names, e.g., “Oak Ridge Turnpike”, and descriptions of other properties in the area, e.g., “Home Depot” and “Oak Ridge Mall.” These designations likewise enable a viewer to observe the location of the property in relation to other properties and the general lay of the land.

View 104 (FIG. 8c) is preferably a floor plan of a selected floor of the property. For example, view 104 is a floor plan of a first floor of the building of the property. Likewise, plans of other floors of the building may be viewed if desired.

Returning now to FIG. 7a, description section 84 preferably includes detailed information such as the name and address of the property, an assigned property identification number that identifies the property in the database, the square footage of buildings, acreage, yearly taxes, dimensions, restrictions, zoning, parking, amenities, such as restrooms, sprinklers, heating and air conditioning, and other specifications of the property.

With reference to FIG. 7b, utility section 86 preferably details the type and terms of utilities available on the property, i.e., gas, electricity, water, and sewer, and the type of property, e.g., commercial, office, restaurant, etc.

Transaction section 88 preferably includes information concerning the type of transaction, e.g., sale, lease, rent or trade, and terms thereof such as the length of lease, the lease/sale price, and other costs associated with the transaction. For example, the section 88 for the purpose of example indicates that the rent is $12.00 per square foot for a three year lease that includes taxes, CAM, insurance, and janitorial service. The cost to build out the space is $12.50 per square foot.

Contact section 90 includes information concerning the identity of the real estate person managing the property, such as name, address, phone/pager/fax numbers, and e-mail address. When selected as by mouse, an e-mail template is preferably generated to facilitate the sending of an e-mail communication.

Optional services section 92 preferably enables selection of additional information concerning a selected property, such as additional maps, images, and video depictions of the interior and exterior of the property.

Community section 94 preferably links to websites of interest, such as link 94a to the local Chamber of Commerce, and information concerning broadcasting and news concerns for the area proximate the property, such as radio, television, newspaper and magazine sources. If desired, links to all or selected ones of the media sources (or other community entities) having Internet webpages may be provided.

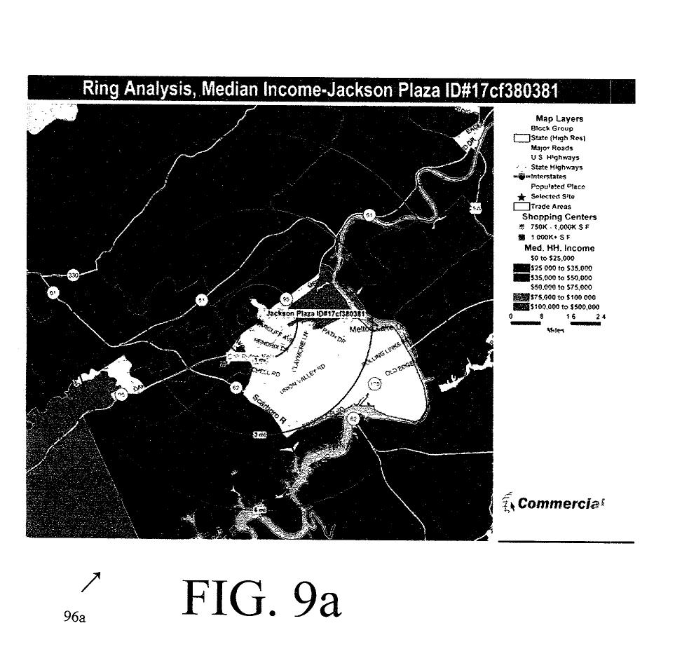

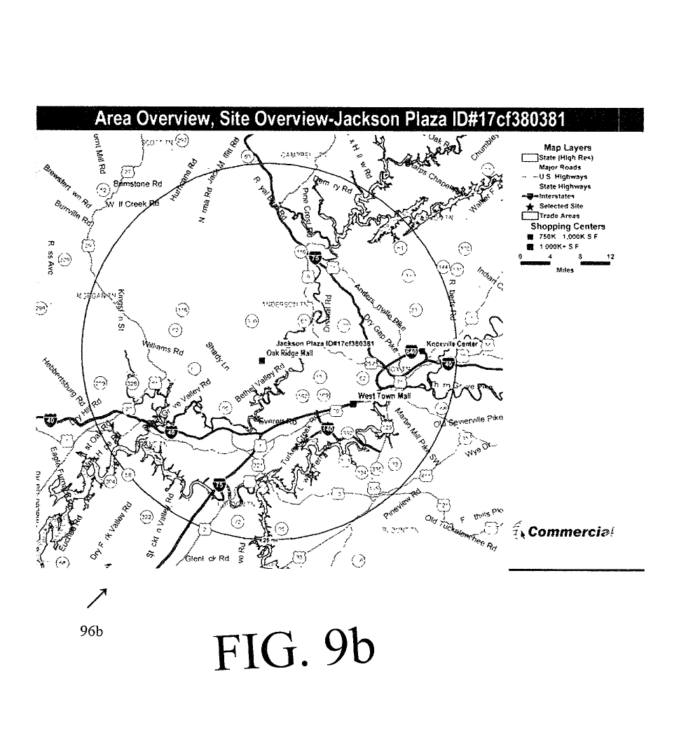

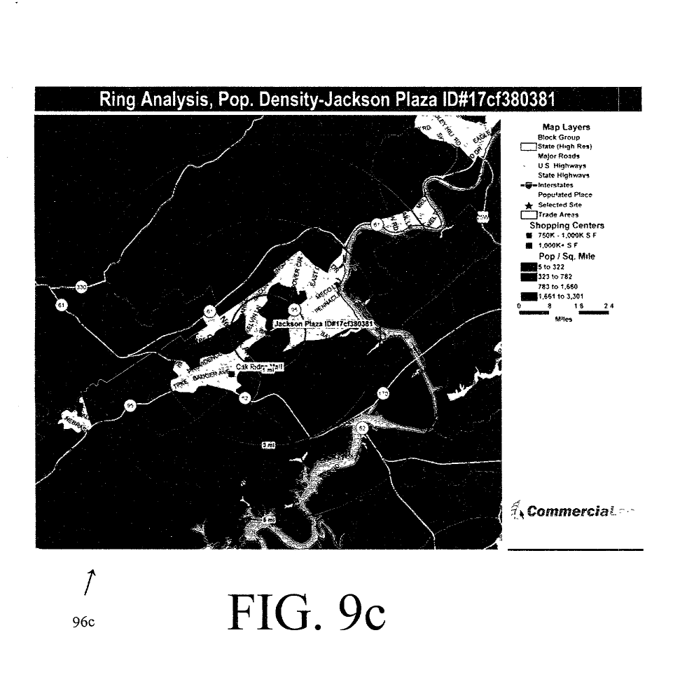

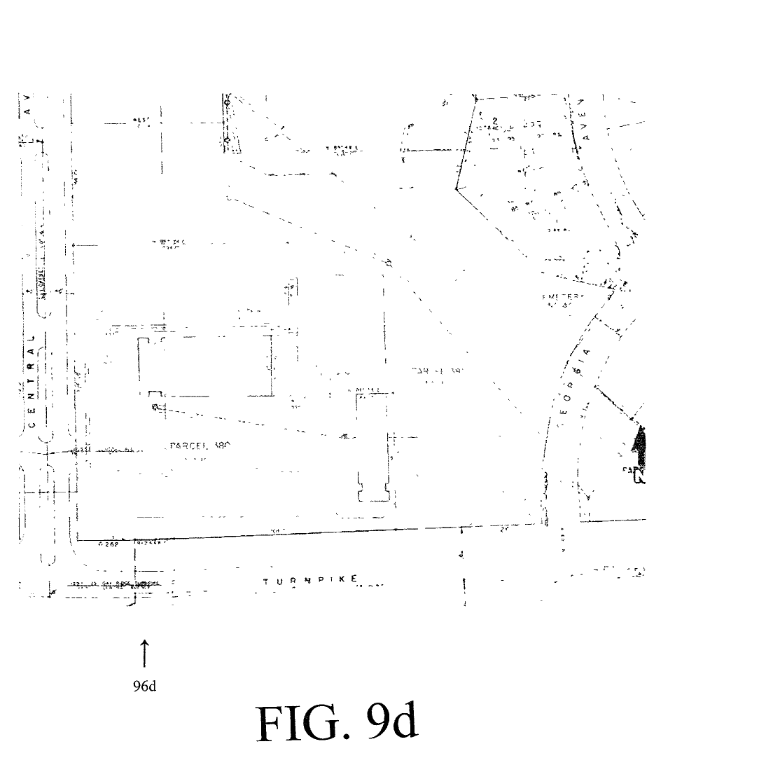

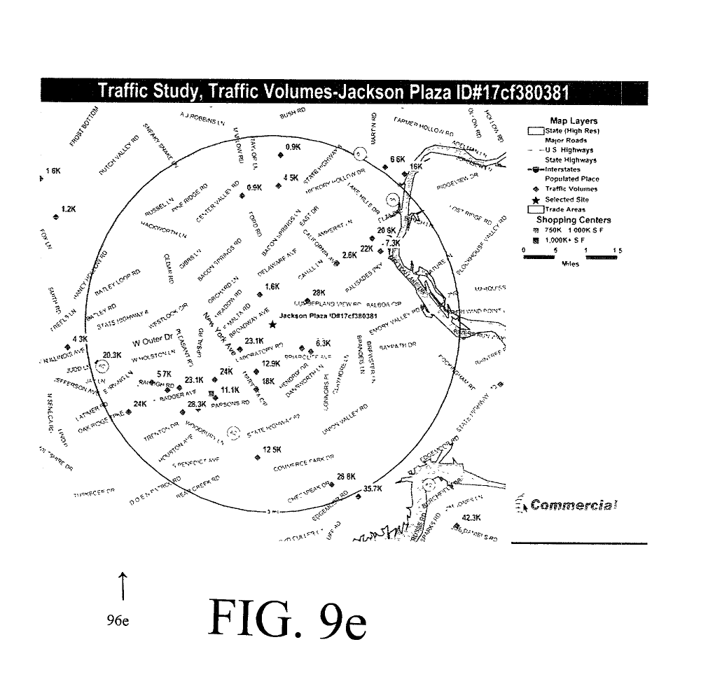

Returning now to FIG. 7c, map section 96 preferably includes thumbnail images 96a-96e of maps of demographic or statistical information concerning the area surrounding the property. For example, map 96a is a map showing median income for the area, map 96b is an overview showing routes, interstates and the like for the area, map 96c is a map of population density, map 96 is a plat map of the property, and map 96e is a map of traffic count. The maps 96a-96e may be enlarged as by clicking on the maps in the section 96. FIGS. 9a-9e are enlarged versions of the maps 96a-96e.

Demographic summary section 98 provides summaries for one or more of the maps 96a-96e. For example, as indicated, section 98 provides a link 98a to a summary page for the traffic count corresponding to map 96e, and a link 98b to a summary page for the demographic information contained in maps 96a and 96c as well as additional demographic information such as gender, age, race and ethnicity, income, spending, and other information concerning residents in the area. It has been observed that information of this nature assembled in a convenient manner is important to selecting commercial real estate. For example, one considering the purchase of a store would likely be interested in population density and economic information of persons within a close proximity to the property.

For the purpose of example, the below Tables 1 and 2 provide examples of preferred information contained in the summary pages accessed via the links 98a and 98b, respectively.

TABLE 1

| | | | | | Straight- |
|---|---|---|---|---|---|
| | | Distance | | | line |
| | | (mi)/ | | Traffic | distance |
| Street | Cross Street | Direction | Year | Volume | (miles) |
| Georgia Ave | E. Tenn. Ave | 0.38 SE | 1993 | 1,550 | 0.5 |
| Fairbanks Rd | Emory Valley | 0.18 SW | 1993 | 3,690 | 0.6 |
| Oak Ridge TP | E. Division | 0.08 NE | 1998 | 23,060 | 0.7 |
| Emory Valley | Fairbanks Rd | 0.28 W | 1993 | 6,270 | 0.7 |
| Oak Ridge TP | Belgrade Rd | 0.34 NE | 1998 | 28,020 | 0.7 |
| Emory Valley | Franklin Rd | 0.25 NE | 1998 | 12,900 | 0.8 |

TABLE 2

| | Within 1 mile | Within 3 mile | Within 5 mi |
|---|---|---|---|
| | radius | radius | radius |
| Population | | | |
| 1990 | 4.34% | 19.74% | 32.78% |
| 2001 | 4.20% | 19.28% | 33.43% |
| 2006 (projected) | 4.24% | 19.53% | 34.29% |
| population density | 1.34 | 695 | 441 |
| (2001) | | | |
| % population growth | −2.4% | −1.9% | 2.1% |
| ('90-00) | | | |
| Trade area size | 3.14% | 27.70% | 75.74% |
| Households | | | |
| Households (1990) | 2.048 | 8.755 | 13.84 |
| Households (2006) | 2.027 | 8.718 | 14.61 |
| Married couples w/ | 330/16.5% | 1653/19.3% | 3152/22.3% |
| children (2001) | | | |
| Gender | | | |
| Male (2001) | 1976 (47%) | 9033 (47%) | 15861 (48%) |
| Female (2001) | 2228 (53%) | 10245 (53%) | 17565 (52%) |
| Race & Ethnicity | | | |
| White (2001) | 4000 (93%) | 17500 (92%) | 30000 (92%) |
| Black (2001) | 200 (4.6%) | 1300 (7%) | 2000 (6%) |
| Other (2001) | 100 (2.4%) | 200 (1%) | 500 (2%) |
| Age Distribution | | | |
| (2001) | | | |
| Age 0-4 | 217 (5.2%) | 1023 | 181 |
| Age 5-9 | 20 (5.0%) | 1154 | 2058 |
| Age 10-13 | 181 (4.3%) | 962 | 171 |
| Age 14-17 | 157 (3.7%) | 877 | 1635 |
| Age 18-24 | 271 (6.4%) | 1271 | 224 |
| Age 25-34 | 532 (12.7%) | 2190 | 3822 |
| Age 35-44 | 605 (14.4%) | 305 | 5370 |
| Age 45-54 | 516 (12.3%) | 2691 | 5056 |
| Age 55-64 | 4 (11.9%) | 2170 | 384 |
| Age 65-74 | 5 (14.2%) | 2288 | 34 |
| Age 75-84 | 337 (8.0%) | 1276 | 1868 |
| Age 85+ | 81 (1.9%) | 316 | 491 |
| Median Age (2001) | 43.02 | 41.4 | 40.67 |
| Median Household | | | |
| Income | | | |
| 1990 | $28032 | $30186 | $30738 |
| 2001 | $37723 | $41120 | $42108 |
| 2006 (projected) | $41416 | $45535 | $46772 |
| Per Capita Income | | | |
| 1990 | $15500 | $15586 | $15124 |
| 2001 | $23720 | $22890 | $22271 |
| 2006 (projected) | $27015 | $26483 | $25800 |
| Income Distribution | | | |
| (2001) | | | |
| HH income $0-$15k | 435 21.7% | 1685 19.6% | 2647 18.7% |
| HH income | 324 16.2% | 1265 14.8% | 2067 14.6% |
| $15k-$25k | | | |
| HH income | 183 9.1% | 805 9.4% | 134 9.5% |
| $25k-$35k | | | |
| HH income | 375 18.7% | 1464 17.1% | 2416 17.0% |
| $35k-$50k | | | |
| HH income | 364 18.2% | 1685 19.6% | 278 19.7% |
| $50k-$75k | | | |
| HH income | 213 10.6% | 1030 12.0% | 1766 12.4% |
| $75k-$100k | | | |
| HH income | 74 3.7% | 475 5.5% | 862 6.1% |
| $100k-$105k | | | |
| HH income $105k+ | 33 1.6% | 168 2.0% | 296 2.1% |
| Housing (1990) | | | |
| units | 2181 | 9448 | 14871 |
| occupied | 2048 | 8755 | 1384 |
| vacant | 133 | 693 | 1022 |
| rent | 1362 | 5634 | 9552 |
| own | 686 | 3121 | 4297 |
| median rent | 280 | 30 | 307 |
| median home value | $59210 | $64,232 | $64016 |
| Consumer Expendi- | | | |
| tures ($$/household) | | | |
| total consumer (2001) | $42635 | $43416 | $44080 |
| total retail (2001) | $17880 | $18175 | $18446 |
| Occupation (1990) | | | |
| executive/managerial | 257 | 1247 | 1981 |
| professional | 386 | 1912 | 3126 |
| technical | 190 | 747 | 1183 |
| sales | 174 | 886 | 144 |
| clerical | 311 | 1290 | 2073 |
| white collar | 131 | 6083 | 9812 |
| total labor force | 1917 | 8966 | 15090 |

Returning now to FIG. 7a, page 80 enables the user to prepare a package relating to the property and to view or print the package, request additional information concerning the property, or have a packaged sent to a desired e-mail address.

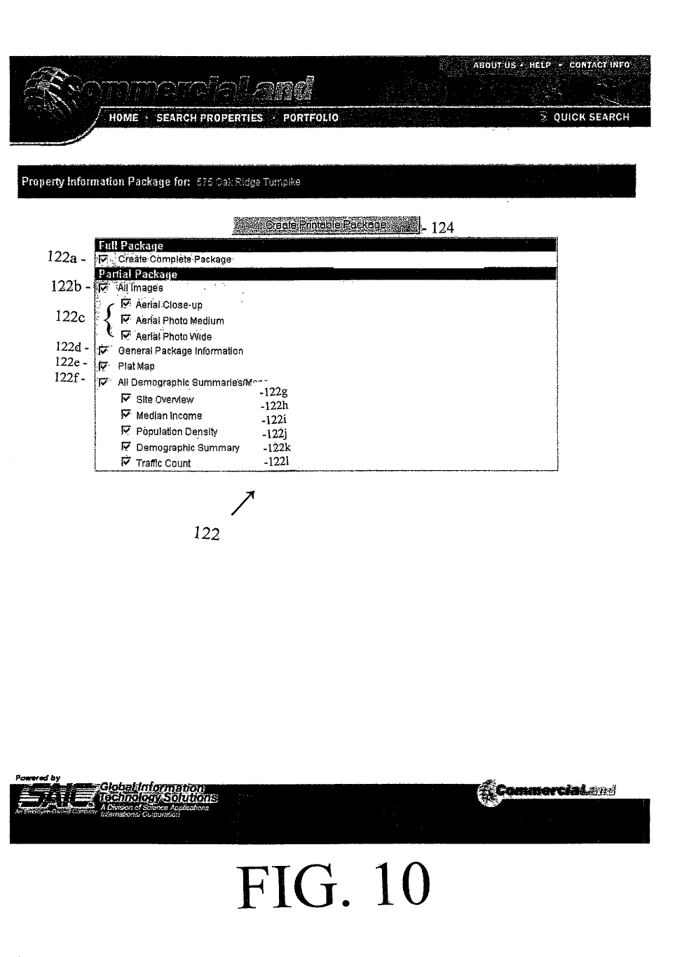

For example, button 120 on page 80 may be selected as by a mouse click to prepare a package and to view and print the package. Selection of button 120 preferably enables the user to access package selection page 122 corresponding to the package input 26 (FIG. 10).

With reference to FIG. 10, page 122 preferably includes fields 122a-122l that enable a user to prepare a default “complete” package containing all available information or a package containing selected information by selecting desired information to be included in the package.

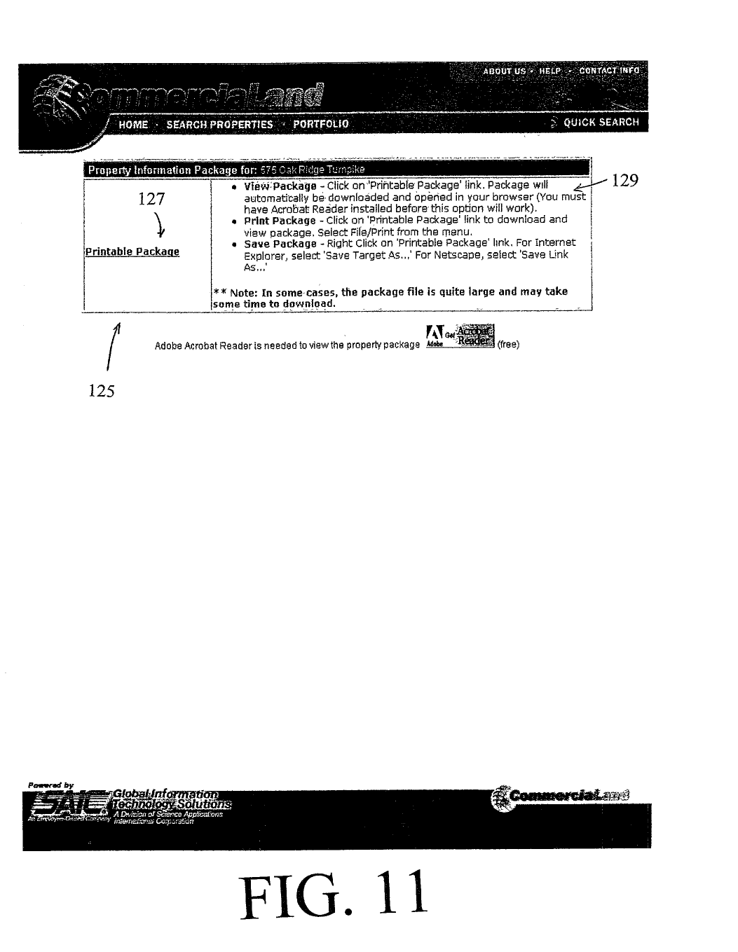

Once desired package selections are made, a “Create Printable Package” icon 124 may be selected as by computer mouse to link the user to package output page 125 (FIG. 11) which corresponds to the package output 28 to generate the desired package. The information provided in the package is preferably custom-selected by the user to meet the needs of the user. The package may then be selectively viewed, printed, and electronically saved by the user.

With reference to FIG. 11, the output page 125 preferably includes “printable package” link 127 which the user may click as by a computer mouse to view, print, and save the selected package. In this regard, the page 125 preferably includes instructions 129 to instruct the user how to view, print, and save the package.

For example, to view a package, the user may click on the link 127 to automatically download and open the package via a conventional Internet web browser and graphics program. The opened package may then be printed as by clicking a print feature of the browser and saved as by clicking on a save feature of the browser.

In a preferred embodiment, users such as commercial real estate agents, may also configure the package to include a cover page bearing the real estate professional's contact information, and to generate additional promotional materials such as flyers or brochures bearing images and information concerning the property.

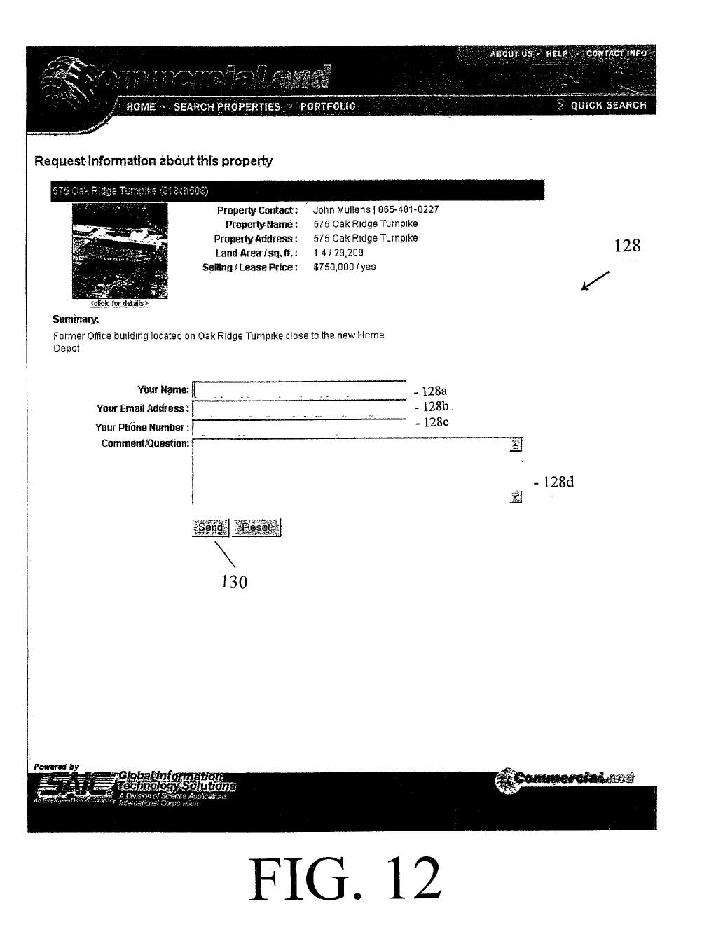

If additional information is desired, button 126 on page 80 (FIG. 7a) may be selected as by a mouse click to access inquiry page 128, a preferred embodiment of which is shown in FIG. 12. The page 128 preferably includes fields 128a-128d to enable the user to input user contact information and to input a query, such as “is this property in a flood plain?” The information is then preferably electronically delivered to the database operator as by selecting send button 130.

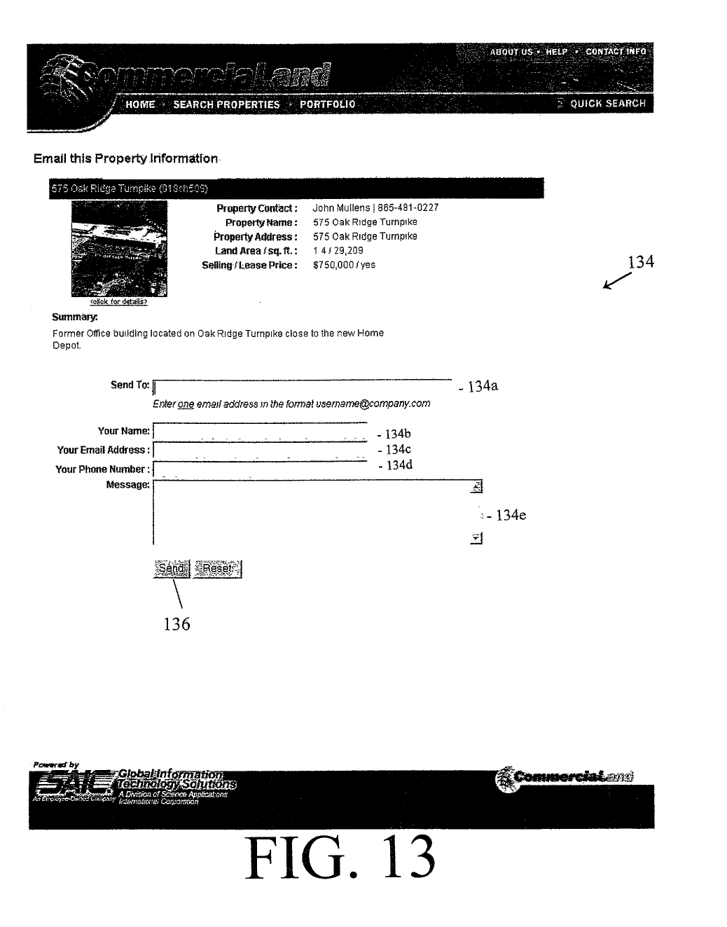

If a user desires to send property information to an e-mail address, the user may select button 132 on page 80 (FIG. 7a) to access e-mail page 134 (FIG. 13). The page 134 preferably includes field 134a to input the recipient's e-mail address, fields 134b-d to input information concerning the user, and field 134e to input a message for the recipient. A command may then be given to electronically send the information to the recipient's e-mail address as by selecting the send button 136. The information to be forwarded may be, for example, the summary information concerning one or more properties and packages relating to one or more packages.

Login Interface 18

As noted previously in connection with FIG. 1, the portfolio interface 12 and administrative interface 14 are preferably protected from general access as by use of passwords and accessed via the login interface 18. For example, general users may search properties and store information in folders outside of the login interface. Clients of the system provider, such as listing users may enter via the login interface 18 to access information relating to their own account. Administrative personnel associated with the system provider may access the system via the login interface for general system support purposes.

For example, users may register to create an account that enables storage of search information in a user folder. Users desiring additional capabilities, such as listing users, may access additional features of the system such as the portfolio interface and selective portions of the administrative interface relating to the account of that user as by registering by submitting a user name and a password via a registration step 140 (FIG. 1). System administrators may also preferably enter the system in this manner.

The user information input via the registration step is preferably required by the login interface 18 to access the portfolio interface and selected portions of the administrative interface. Various restricted portions of the administrative interface are preferably accessible only by authorized persons for the purpose of maintaining and operating the system for users. This access is also preferably enabled via the login interface using passwords and user names.

Portfolio Interface 12

Returning to FIG. 1, the portfolio interface is accessible via the login interface 18 and includes portfolio folder 144 having associated folder tools 146. The tools can be used to perform selected functions using information stored in the folder 144, such as to send the information to the package input 26 for manipulation thereof as described above in connection with the user interface 10, or to marketing step 148.

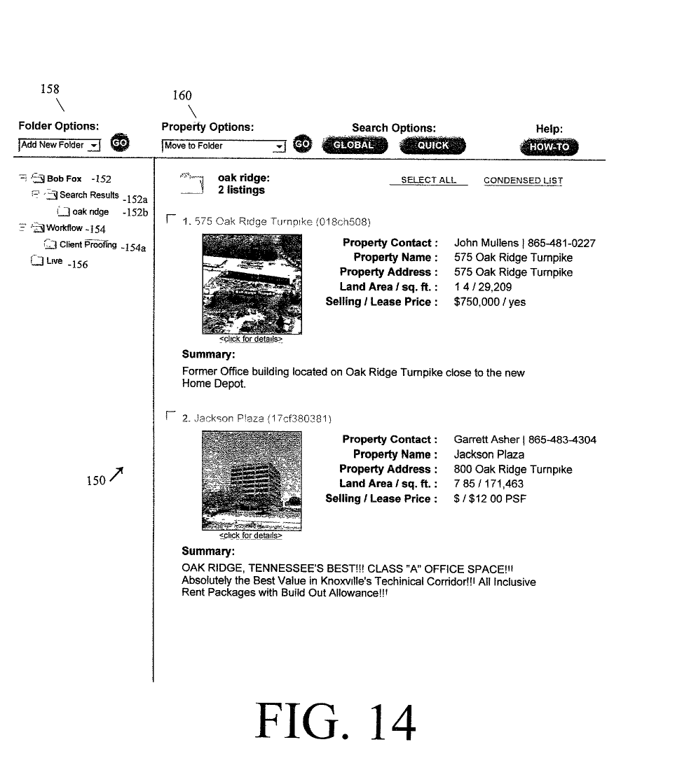

For example, with reference to FIG. 14, there is shown a preferred page 150 containing access to the folder 144 and tools 146. For example, the page 150 includes links to folders 152-156. Tool windows such as folder options window 158 and property options 160 enable the performance of tasks with regard to the folders and the contents, e.g., properties, therein.

Each user having the ability to login and enter the portfolio interface will have an individual portfolio including page 150, with folders 152-156 personal to that user. For the purpose of example, the folders 152-156 will be described in the context of folders for an individual user, it being understood that the system includes a plurality of such pages and folders, one for each authorized user.

Folder 152 is preferably a folder bearing the name of the user, in this case, “bob fox.” The folder 152 enables selective storage of search results obtained as by searching in manners corresponding to those previously described. The search results may be stored in a general search folder 152a, or in subfolders such as subfolder 152b. Subfolder 152b is, for the purpose of example, entitled “oak ridge” as it contains selected results from a search to locate properties located in Oak Ridge.

Page 70 as depicted in FIG. 6, shows the contents of folder 152b, with the contents preferably presented in a format that provides an image of each property as well as desired information such as address, land area/square footage, and price. Optionally, icon 162 may be selected to access a page wherein the properties are displayed in a condensed or tabulated form, such as:

| select | name | street | city | state | contact | Id. No. |
|---|---|---|---|---|---|---|
| | Bank | Main | Oak Ridge | TN | J. Mullens | 018ch508 |
| | Jackson Plaza | Tenth | Oak Ridge | TN | G. Asher | 17f33803 |

The above table is preferably interactive so as to enable sorting of column contents. For example, the “street” heading may be accessed as by a mouse click to sort the properties alphabetically by street name, with properties of the same street name being sorted by street number, with an additional mouse click on the heading returning the items to their prior unsorted orientation. Likewise the other heading information is also preferably able to be sorted or otherwise selectively ordered.

For folders 152, 152a, and 152b, the preferred folder options available as by window 158 include “Add New Folder,” “Email Folder,” “Delete Folder,” “Move Folder,” and “Rename Folder.” For example, if it is desired to add a new folder, for example, to store properties from a new search, a new folder bearing a desired name may be added by selecting the “Add New Folder” option, with the user being cued for the desired name. The properties to be added to the new folder are selected using the “Add to Folder” option of window 160.

Preferred property options for folders 152, 152a, and 152b available as by window 160 include: “Remove From Folder,” “Add To Folder,” “E-mail Property Info,” “Request Info,” and “Print Property Info.” For example, if it is desired to remove a property from a folder, a box next to the property on page 70 may be checked as by a mouse click and the “Remove From Folder” option selected. Other of the options link the user to previously described features, such as e-mailing, requesting additional information, and printing features.

A general user desiring only to save search information would preferably access a page similar to page 150, but only including search folders, such as folder 152 and 152a, and windows 158 and 160.

Folder 154 is preferably a folder that enables users to monitor the progress of properties that are designated to the system operator as properties to be included in the database, but not yet available in the database. For example, a user, such as a real estate professional may have several properties that are to be added to the database. To initiate this, the user contacts the system operator concerning the property.

The operator then obtains and configures the information to be included in the database. This includes obtaining all of the information described previously in connection with the search output 24, such as images, demographics, and the like. In preparing the information concerning the property or properties, the operator preferably electronically communicates the information to the user via the folder 154 for approval or comments. The communicated information is preferably stored in client proofing subfolder 154a. The user is preferably charged a fee by the operator for preparing the property information to be added to the database and for maintenance of the system. The user may have additional subfolders if desired to hold information for listings in various stages of review. For example, an “approved” folder to hold approved listings of the user.

The preferred folder options available for folders 154, 154a as by window 158 include “Add New Folder,” “Email Folder,” “Delete Folder,” “Move Folder,” and “Rename Folder.”

Preferred property options for folders 154, 154a available as by window 160 include: “Approve,” “Return To AD Proofing,” “E-mail Property Info,” and “Print Property Info.” For example, if the information is acceptable to the user, the user notifies the operator by selecting “Approve.” If the information needs modification, “Return to AD Proofing” is selected to notify the area director (AD) of the modifications to be made. This feature links the user to a comments page wherein the user can type in the needed changes. Optionally, the user can be permitted access to actually make modifications to the information.

Each folder 156 is preferably a collection of all listed properties for a particular listing user. Subfolder 156 may further include subfolders in the same manner as the folders 152 and 154. For example, a subfolder may be created corresponding to the different geographic regions of listed properties, e.g.. a “Texas properties” subfolder would preferably contain all properties in Texas listed by the user.

The preferred folder options available for folder 156 as by window 158 include “Add New Folder,” “Email Folder,” “Delete Folder,” “Move Folder,” and “Rename Folder.”

Preferred property options for folder 156 available as by window 160 include: “E-mail Property Info” and “Print Property Info.” Other preferred options, corresponding to marketing steps 146, include options suitable for configuring other promotional materials such as personalized flyers depicting images and information concerning a selected property, and for ordering printed copies of the flyers, printing the flyer, or electronically communicating the flyer to a third party.

As a further part of the marketing steps 146, it is preferred to enable listing users to maintain and review statistics associated with their marketing efforts. For example, electronic information is preferably maintained in the folder 156 (or subfolders thereof) corresponding to the length of time each listed property has been listed, when properties have been sold, how many other users have viewed, printed or e-mailed information relating to a particular property, how many e-mails or other communications the user has sent out concerning each property, and other information relating to acts taken with respect to each particular property by the listing user or other users.

This information may be reviewed, compiled, or otherwise manipulated by a listing user to evaluate the effectiveness of their marketing efforts. For example, the information preferably enables each listing user to evaluate the average number of listing days for each property before it is sold and to evaluate the effectiveness of particular marketing approaches. That is, the user may preferably determine from the information whether a purchaser was contacted by the listing user, as by e-mail or by mail or otherwise, and whether the purchaser accessed the information independently. The compiled information may be interacted via the website as by conventional spreadsheet algorithms included as a property option via the window 160 and downloaded for off-site evaluation using independent computer apparatus and software.

Administrative Interface 14

Returning to FIG. 1, the administrative interface 14 preferably enables the system operator to input and edit information concerning properties to be listed and listed properties. For example, in a preferred embodiment, a potential listing user for a particular property interacts, as indicated by step 170, with the operator to identify the property to be listed, makes arrangements for payment to the operator, and otherwise becomes approved as a client and receives information for logging into the system.

The operator proceeds with preparing the listing information, such as by obtaining and preparing images and information, as previously described. The information is preferably prepared as indicated by step 172, and preferably in stages 172a-17d by persons having particular tasks to perform. For example, in step 172a initial information such as images, demographic, and physical information is input to create a listing record 174.

Information concerning the listing record 174 is then processed via an editor in step 172b wherein edits are made and the information is returned to step 172a with editing instructions in the mainer described previously with regard to the folders 154, 154a. Once a listing record 174 is approved in step 172b, step 172c provides the listing user with the information. The user can approve, request changes, or optionally edit the information. Once approval is received from the user, the listing record 174 is incorporated via step 172d into the database of listed properties.

Information concerning the payment or billing information of a user such as a listing user, with regard to a property is preferably maintained in billing record 180. This information may be accessed for each of the properties of a listing user to facilitate the maintenance of business records and the like. This information may preferably be compiled as in summary tables or otherwise accessed and interacted with via the portfolio interface 12 and downloaded for off-site use.

Statistical information, such as the information described in connection with marketing step 146, concerning the marketing efforts and accesses made by other users to a particular property listing are preferably generated and maintained in marketing record 182. For example, the system preferably maintains data corresponding to events such as requests for packages concerning a particular property, requests for e-mailing of information concerning a property, and each of the events that can occur as a result of a property being included in the database. As described previously, this information may preferably be accessed and interacted with via the portfolio interface and downloaded for off-site use.

The foregoing description of certain exemplary embodiments of the present invention has been provided for purposes of illustration only, and it is understood that numerous modifications or alterations may be made in and to the illustrated embodiments without departing from the spirit and scope of the invention as defined in the following claims.

What is claimed is:

1. A computerized real estate information system accessible via a computer network for selectively providing information to users concerning real estate properties, the system comprising:
a computer database of information corresponding to real estate properties;
a user access interface operatively associated with the database for selectively accessing the database information, the user interface including
a portal to a global computer network,
a plurality of search data entry fields accessible via the portal for inputting desired search criteria for comparison to the database information to yield at least one search result corresponding to a subset of the database information that matches the input search criteria,
a search result display that visually presents the search result,
first package data entry fields for selecting desired database information for inclusion in a first package of information corresponding to a desired real estate property, and
at least one first package output field for selecting a desired package output format;
a portfolio interface operatively associated with the user interface for organizing information concerning selected ones of the real estate properties, the portfolio interface including
a plurality of portfolio folders for storing selected database information corresponding to at least one of the real estate properties, and
a plurality of folder tools associated with each of the portfolio folders, the folder tools including
second package data entry fields for selecting desired database information for inclusion in a second package of information corresponding to a desired real estate property, and
at least one second package output field for selecting a desired package output format; and
an administrative interface for entering the information corresponding to the real estate properties into the database and for editing the information.

2. The system of claim 1, wherein the information corresponding to real estate properties comprises photographs of properties, text, and maps.

3. The system of claim 2, wherein the photographs for each property comprises at least one aerial photograph.

4. The system of claim 3, wherein at least one of the aerial photographs of a property further includes a highlighted border substantially corresponding to property lines of the property.

5. The system of claim 4, wherein the at least one of the aerial photographs includes text identifying one or more features proximate to the property, the features being selected from the group consisting of street names and property descriptions.

6. The system of claim 2, wherein the text is selected from the group consisting of property codes, names of persons, property descriptions, phone numbers, address information, property types, price, property age, square footage, acreage, and transaction type.

7. The system of claim 2, wherein the maps comprise maps of demographic information for areas proximate a selected real property.

8. The system of claim 7, wherein the maps selected from the group consisting of income, roads, population, plat, and traffic.

9. The system of claim 1, wherein the desired search criteria is selected from the group consisting of property codes, names of persons, property descriptions, phone numbers, address information, property types, price, age, square footage, acreage, and transaction type.

10. The system of claim 1, wherein the search data entry fields are selected from the group consisting of property codes, names of persons, property descriptions, phone numbers, address information, property types, price, property age, square footage, acreage, and transaction type.

11. The system of claim 1, wherein the search result display comprises a display having an images section, a description section, a utilities section, a transaction section, a contact section, a community section, and a map section.

12. The system of claim 11, wherein the image section comprises a photograph.

13. The system of claim 11, wherein the description section includes textual information selected from the group consisting of property codes, names of persons, property descriptions, phone numbers, address information, property types, price, age, square footage, acreage, and transaction type.

14. The system of claim 11, wherein the utilities section includes textual information corresponding to utilities selected from the group consisting of gas, electricity, water, and sewer.

15. The system of claim 11, wherein the transaction section includes textual information corresponding to transaction types selected from the group consisting of sales, leases, rentals, and trades.

16. The system of claim 11, wherein the contact section includes textual information selected from the group consisting of names, addresses, phone numbers, fax numbers, pager numbers, and e-mail addresses

17. The system of claim 11, wherein the community section includes information corresponding to media providers from the group consisting of radio and television stations and newspapers.

18. The system of claim 11, wherein the map section includes maps ofinformation selected from the group consisting of income, roads, population, plat, and traffic.

19. The system of claim 11, further comprising a demographic section having information demographic information selected from the group consisting of gender, age, race, ethnicity, income, and spending.

20. The system of claim 1, wherein the first package data entry fields are selected from the group consisting of maps, community information, photographs, and demographic information.

21. The system of claim 1, wherein the first package includes printed pages containing information selected from the group consisting of maps, community information, photographs, and demographic information.

22. The system of claim 1, wherein the first package output field is selected from the group consisting of view, print, and save.

23. The system of claim 1, wherein the portfolio folder comprises a search storage folder containing a subset of the database information that matches input search criteria.

24. The system of claim 1, wherein the user is a listing user and the portfolio folder comprises a folder containing property information to be approved by the listing user.

25. The system of claim 1, wherein the second package data entry fields are selected from the group consisting of maps, community information, photographs, and demographic information.

26. The system of claim 1, wherein the second package includes printed pages containing information selected from the group consisting of maps, community information, photographs, and demographic information.

27. The system of claim 1, wherein the second package output field is selected from the group consisting of view, print, save, and send.

28. The system of claim 27, wherein the second field comprises electronic mailing of a package.

29. The system of claim 1, wherein the user is a listing user and the portfolio folder comprises a collection of all listed properties for the listing user and includes information corresponding to the length of time each listed property of the listing user has been listed, when properties have been sold, how many other users have viewed, printed or e-mailed information relating to a particular property, and how many e-mails and other communications the listing user has sent concerning each property.

30. The system of claim 29, wherein the second package comprises statistical information corresponding to marketing efforts of the listing user for properties listed by the listing user, the statistical information being selected from the group consisting of the length of time each listed property of the listing user has been listed, when properties have been sold, how many other users have viewed, printed or e-mailed information relating to a particular property, and how many e-mails and other communications the listing user has sent concerning each property.

31. The system of claim 1, further comprising a login interface that limits access to the portfolio interface and the administrative interface.

32. A computerized real estate information system accessible via a computer network for selectively providing information to users concerning real estate properties, the system comprising:
a computer database of information corresponding to real estate properties, a user access interface operatively associated with the database for selectively accessing the database information, a portfolio interface operatively associated with the user interface for organizing information concerning selected ones of the real estate properties, and an administrative interface for entering the information corresponding to the real estate properties into the database and for editing the information, wherein the portfolio interface is accessible via a login interface and includes tools to select information from the database and to generate a package corresponding to the selected information.

33. The system of claim 32, wherein the package includes printed pages containing information selected from the group consisting of maps, community information, photographs, and demographic information.

34. The system of claim 32, wherein the package comprises statistical information corresponding to marketing efforts of the listing user for properties listed by the listing user, the statistical information being selected from the group consisting of the length of time each listed property of the listing user has been listed, when properties have been sold, how many other users have viewed, printed or e-mailed information relating to a particular property, and how many e-mails and other communications the listing user has sent concerning each property.
